(19) United States
(12) Patent Application Publication
(10) Pub. No.: US 2021/0387267 A1
(43) Pub. Date: Dec. 16, 2021

(54) METHOD OF PERFORMING A CUTTING OPERATION ON A WORKPIECE

(71) Applicant: NO SCREW LTD, Hevel Modi'in (IL)

(72) Inventor: Gershon Harif, Ramat Gan (IL)

(21) Appl. No.: 17/297,043

(22) PCT Filed: Nov. 25, 2019
(86) PCT No.: PCT/IL2019/051285

§ 371 Date: May 26, 2021

Related U.S. Application Data
(60) Provisional application No. 62/772,641, filed on Nov. 29, 2018.
(60) Provisional application No. 62/816,128, filed on Mar. 10, 2019.

(51) Int. Cl. B23B 35/00; B23B 27/10

(52) U.S. Cl. CPC B23B 35/00; B23B 27/10; B23B 2220/36; B23B 2200/0419; B23B 2200/08; B23B 2200/3618; B23B 2250/12

(57) ABSTRACT

A method for performing a cutting operation on a workpiece is provided. The method comprises providing a workpiece being made of a metal characterized by a thermal conductivity of no greater than about 100 W100 ^{W}/_{(m·K)} (approximately 57.8 ^{Btu}/_{(hr ft ° F.)}), providing a cutting device comprising an internal cooling cavity defined on one side thereof by a thin-walled structure, and performing a cutting operation on the workpiece using the cutting device. The cutting speed is no less than about 500 ^{m}/_{min.} (approximately 1640 ^{ft}/ₘᵢₙ).

### TECHNOLOGICAL FIELD

The presently disclosed subject matter relates to methods for performing cutting operations on a workpiece, in particular at high speeds.

### BACKGROUND

Cutting tools are commonly used in machining operations. Such cutting tools typically comprise a cutting tool holder, and a replaceable cutting insert mounted thereon. The cutting insert performs the actual machining, and thus is subject to wear resulting therefrom. This wear arises from, e.g., heat, mechanical stress, etc.

In typical use, once a cutting insert has been subject to sufficient wear that it is no longer effective to perform its required function, the machining operation is halted, and the cutting insert is replaced. It is well-known that the useful life of a cutting insert depends, inter alia, on the temperature and/or cutting forces it experiences during use.

### SUMMARY

According to a first aspect of the presently disclosed subject matter, there is provided a method for performing a cutting operation on a workpiece, the method comprising:
providing the workpiece, the workpiece being made of a metal characterized by a thermal conductivity of no greater than about 100 ^{W}/_{(m·K)} (approximately 57.8 ^{Btu}/_{(hr·ft·° F.)});
providing a cutting device comprising an internal cooling cavity defined on one side thereof by a thin-walled structure; and
performing, using the cutting device, a cutting operation on the workpiece, wherein the cutting speed is no less than about 300 ^{m}/_{min.} (approximately 984 ^{ft.}/_{min.}). According to some examples, the cutting speed in no less than about 500 ^{m}/_{min.} (approximately 1640 ft/min.).

The metal may be characterized by continuous chipping, i.e., it may undergo a cutting operation such that the material of the workpiece removed is in the form of continuous chips. The metal may be characterized by lamellar chipping, i.e., it may undergo a cutting operation such that the material of the workpiece removed is in the form of lamellar chips. The metal may be characterized by short chipping, i.e., it may undergo a cutting operation such that the material of the workpiece removed is in the form of short chips, for example shearing off in small particles that are powder- and/or particulate-like.

The metal may be selected from a group including iron, copper alloys, steel, lead, titanium, and nickel.

The cutting device may comprise a replaceable insert. The insert may be made of a material selected from a group including carbide, steel, and widia.

The cutting device may comprise a rake surface, a relief surface, and a cutting edge defined therebetween, the relief surface and/or the rake surface (which may include or be at least a portion of a chip breaker of the cutting device) being disposed on the thin-walled structure.

The thin-walled structure may be provided such that its minimum thickness does not exceed approximately 0.7 mm. The thin-walled structure may be provided such that its minimum thickness does not exceed approximately 0.4 mm.

The cutting device may be characterized in that the thin-walled structure is not suited to withstand cutting forces associated with lowering the cutting speed to less than about 100 ^{m}/_{min.} (approximately 328 ^{ft.}/_{min.}).

The cutting device may be characterized in that the thin-walled structure is not suited to withstand cutting forces associated with lowering the cutting speed to less than about 300 ^{m}/_{min.} (approximately 984 ^{ft.}/_{min.}).

The cutting operation may be selected from a group including a turning operation, a milling operation, and a drilling operation.

Continuous, short, and/or lamellar chipping may occur during the cutting operation.

The method may further comprise supplying a cooling fluid to the cooling cavity during the cutting operation.

The method may be characterized in that the useful life of the cutting device is higher when the cutting speed is increased, i.e., increasing the cutting speed may increase the useful life of the cutting device.

The method may be characterized in that higher chip thicknesses are obtained when the cutting speed is increased, i.e., increasing the cutting speed may facilitate producing chips of higher chip thickness without causing undue damage or wear to the cutting device.

According to a second aspect of the presently disclosed subject matter, there is provided a combination comprising:
one or more cutting devices, each comprising an internal cooling cavity defined on one side thereof by a thin-walled structure; and
at least one article providing instructions for use of the cutting devices in accordance with a method for performing a cutting operation on a workpiece, the method comprising:
   providing the workpiece, the workpiece being a metal characterized by a thermal conductivity of no greater than about 100 ^{W}/_{(m·K)} (approximately 57.8 ^{Btu}/_{(hr·ft·° F.)}); and
   performing, using one of the cutting devices, a cutting operation on the workpiece, wherein the cutting speed is no less than about 300 ^{m}/_{min.}(approximately 984 ^{ft.}/_{min.}). According to some examples, the cutting speed in no less than about 500 ^{m}/_{min.} (approximately 1640 ^{ft.}/_{min.}).

The metal may be characterized by continuous chipping, i.e., it may undergo a cutting operation such that the material of the workpiece removed is in the form of continuous chips. The metal may be characterized by lamellar chipping, i.e., it may undergo a cutting operation such that the material of the workpiece removed is in the form of lamellar chips. The metal may be characterized by short chipping, i.e., it may undergo a cutting operation such that the material of the workpiece removed is in the form of short chips, for example shearing off in small particles that are powder- and/or particulate-like.

The metal may be selected from a group including iron, copper alloys, steel, lead, titanium, and nickel.

The cutting device may comprise a replaceable insert. The insert may be made of a material selected from a group including carbide, steel, and widia.

The cutting device may comprise a rake surface, a relief surface, and a cutting edge defined therebetween, the relief surface and/or the rake surface being disposed on the thin-walled structure.

The thin-walled structure may be provided such that its minimum thickness does not exceed approximately 0.7 mm. The thin-walled structure may be provided such that its minimum thickness does not exceed approximately 0.4 mm.

Each of the cutting devices may be characterized in that the thin-walled structure is not suited to withstand cutting forces associated with lowering the cutting speed to less than about 100 ^{m}/_{min.} (approximately 328 ^{ft}/_{min.}).

Each of the cutting devices may be characterized in that the thin-walled structure is not suited to withstand cutting forces associated with lowering the cutting speed to less than about 300 ^{m}/_{min.} (approximately 984 ^{ft.}/_{min.}).

The cutting operation may be selected from a group including a turning operation, a milling operation, and a drilling operation.

The method may further comprise supplying a cooling fluid to the cooling cavity during the cutting operation.

The instructions may indicate two or more values of estimated useful life for each cutting device when performing a cutting operation on a workpiece of a specified material, each of the values being associated with a different cutting speed, wherein the values of estimated useful life increase with increased cutting speeds.

The instructions may indicate two or more values of chip thickness for each cutting device when performing a cutting operation on a workpiece of a specified material, each of the values being associated with a different cutting speed, wherein the values of chip thickness increase with increased cutting speeds.

According to a third aspect of the presently disclosed subject matter, there is provided a method for performing a cutting operation on a workpiece, the method comprising:
providing the workpiece;
providing a cutting device, the cutting device comprising an internal cooling cavity defined on one side thereof by a thin-walled structure; and
performing, using the cutting device, a cutting operation on the workpiece at a characteristic operational speed being no less than a maximum characteristic reference speed;
   wherein the maximum characteristic reference speed is the highest characteristic speed below which performing a reference cutting operation on the workpiece with the cutting device is associated with structural failure of the thin-walled structure.

It will be appreciated that herein the specification and claims, a cutting condition, such as a characteristic cutting speed, may be considered to be “associated with” a phenomenon, such as structural failure or thermal failure, if the phenomenon can be expected to occur at a rate which would be unacceptable to a user having an ordinary level of skill in the art of using such a cutting tool. It is not to be understood to indicate that under conditions not associated with the phenomenon that the phenomenon never occurs, or that under conditions associated with the phenomenon that it always occurs. The condition may be determined calculated, for example using finite element analysis as is well known in the art, and/or experimentally.

The characteristic operational speed may be at least 1.5 times greater than the maximum characteristic reference speed. The characteristic operational speed may be at least two times the maximum characteristic reference speed.

The reference cutting operation may be a continuous cutting operation (as opposed to an intermittent or interrupted cutting operation).

Each of the characteristic speeds may be a respective cutting speed (i.e., the “characteristic operational speed” is the operational cutting speed, the “maximum characteristic reference speed” is the maximum reference cutting speed, and the “characteristic operational speed” is the characteristic cutting speed).

Each of the characteristic speeds may be calculated based on a respective cutting speed and a respective feed rate. The characteristic speeds always increase with an increase of each of the respective cutting speed and respective feed rate, but they are not necessarily given equal weight in calculating the characteristic speeds. For example, each of the characteristic speeds may be the sum of the respective cutting speed and the respective feed rate, the sum of the respective cutting speed multiplied by a first coefficient and the respective feed rate multiplied by a second coefficient, the square root of the sums of the squares of the respective cutting speed and the respective feed rate, etc.

The cutting device may comprise a cutting portion made of a material selected from a group including carbide, steel, and widia.

The method may further comprise supplying a cooling fluid to the cooling cavity, thereby reducing the temperature of the cutting device near its cutting edge.

The workpiece may be made of a metal characterized by a thermal conductivity of no greater than about 100 ^{W}/_{(m·K)} (approximately 57.8 ^{Btu}/_{(hr·ft·° F.)}).

The material of the workpiece may be characterized by continuous chipping.

The material of the workpiece may be characterized by lamellar chipping.

The material of the workpiece may be characterized by short chipping.

The workpiece may be made of a material metal selected from a group including iron, copper alloys, steel, lead, titanium, and nickel.

The thin-walled structure may span between the cooling cavity and at least a portion of a relief surface and/or a rake surface of the cutting device.

The thin-walled structure may have a minimum thickness not exceeding approximately 0.7 mm.

The thin-walled structure may have a minimum thickness not exceeding approximately 0.4 mm.

The thin-walled structure may have a minimum thickness not exceeding approximately 0.2 mm.

The thin-walled structure may have a minimum thickness not exceeding approximately 0.1 mm.

The cutting device may comprise one or more ribs projecting into the cavity from a top end thereof.

The maximum characteristic reference speed may be no greater than about 100 ^{m}/_{min.} (approximately 328 ^{ft.}/_{min.}).

The maximum characteristic reference speed may be no greater than about 300 ^{m}/_{min.} (approximately 984 ^{ft.}/_{min.}).

The characteristic operational speed may be no less than about 500 ^{m}/_{min.} (approximately 1640 ^{ft.}/_{min.}).

The cutting device may comprise a replaceable insert.

The cutting operation may be selected from a group including a turning operation, a milling operation, and a drilling operation.

The method may be characterized in that the useful life of the cutting device is higher when the cutting speed is increased.

According to a fourth aspect of the presently disclosed subject matter, there is provided a combination comprising:
one or more cutting devices, each comprising an internal cooling cavity defined on one side thereof by a thin-walled structure; and
at least one article providing instructions for use of one of the cutting devices using the method according to the third aspect of the presently disclosed subject matter.

According to a fifth aspect of the presently disclosed subject matter, there is provided a method for determining a minimum characteristic operational speed for a cutting operation on a workpiece, the method comprising:
selecting the workpiece;
selecting a cutting device, the cutting device comprising a cutting edge and a corresponding fault region, and being associated with a cooling arrangement configured to act thereof to lower its temperature at least in the vicinity of the cutting edge during use of the cutting device;
determining a maximum characteristic reference speed being the highest characteristic speed below which performing a reference cutting operation on the workpiece with the cutting device is associated with structural failure in the fault region; and
determining the minimum characteristic operational speed to be above the maximum characteristic reference speed.

The characteristic operational speed may be at least 1.5 times greater than the maximum characteristic reference speed. The characteristic operational speed may be at least two times the maximum characteristic reference speed.

The reference cutting operation may be a continuous cutting operation (as opposed to an intermittent or interrupted cutting operation).

Each of the characteristic speeds may be a respective cutting speed (i.e., the “minimum characteristic operational speed” is the minimum operational cutting speed, and the “maximum characteristic reference speed” is the maximum reference cutting speed).

Each of the characteristic speeds may be calculated based on a respective cutting speed and a respective feed rate. The characteristic speeds always increase with an increase of each of the respective cutting speed and respective feed rate, but they are not necessarily given equal weight in calculating the characteristic speeds. For example, each of the characteristic speeds may be the sum of the respective cutting speed and the respective feed rate, the sum of the respective cutting speed multiplied by a first coefficient and the respective feed rate multiplied by a second coefficient, the square root of the sums of the squares of the respective cutting speed and the respective feed rate, etc.

The cutting device may comprise a cutting portion made of a material selected from a group including carbide, steel, and widia.

The method may further comprise supplying a cooling fluid to the cooling cavity, thereby reducing the temperature of the cutting device near its cutting edge.

The workpiece may be made of a metal characterized by a thermal conductivity of no greater than about 100 ^{W}/_{(m·K)} (approximately 57.8 ^{Btu}/_{(hr·ft·° F.)}).

The material of the workpiece may be characterized by continuous chipping.

The material of the workpiece may be characterized by lamellar chipping.

The material of the workpiece may be characterized by short chipping.

The workpiece may be made of a material metal selected from a group including iron, copper alloys, steel, lead, titanium, and nickel.

The cutting operation may comprise operating the cooling arrangement to reduce the temperature of the cutting device near its cutting edge.

The cooling arrangement may comprise an internal cooling cavity formed in the cutting device, the internal cooling cavity being defined on one side thereof by a thin-walled structure comprising at least a portion of the fault region, and spanning between the cooling cavity and at least a portion of a relief surface and/or a rake surface of the cutting device.

The thin-walled structure may have a minimum thickness not exceeding approximately 0.7 mm.

The thin-walled structure may have a minimum thickness not exceeding approximately 0.4 mm.

The thin-walled structure may have a minimum thickness not exceeding approximately 0.2 mm.

The thin-walled structure may have a minimum thickness not exceeding approximately 0.1 mm.

The cutting device may comprise one or more ribs projecting into the cavity from a top end thereof.

The maximum characteristic reference speed may be no greater than about 100 ^{m}/_{min.} (approximately 328 ^{ft.}/_{min.}).

The maximum characteristic reference speed may be no greater than about 300 ^{m}/_{min.} (approximately 984 ^{ft.}/_{min.}).

The characteristic operational speed may be no less than about 500 ^{m}/_{min.} (approximately 1640 ^{ft.}/_{min.}).

The cutting device may comprise a replaceable insert.

The cutting operation may be selected from a group including a turning operation, a milling operation, and a drilling operation.

The method may be characterized in that the useful life of the cutting device is higher when the cutting speed is increased.

According to a sixth aspect of the presently disclosed subject matter, there is provided a cutting device designed according to the method of the fifth aspect of the presently disclosed subject matter.

According to a seventh aspect of the presently disclosed subject matter, there is provided a combination comprising:
one or more cutting devices, each comprising an internal cooling cavity defined on one side thereof by a thin-walled structure; and
at least one article providing instructions for use of the cutting devices in accordance with a method for performing a cutting operation on a workpiece, the method comprising:
   providing the workpiece;
   supplying a cooling fluid to the cooling cavity; and
   performing, using one of the cutting devices, a cutting operation on the workpiece, at a minimum characteristic operational speed being no less than 1.5 times a maximum characteristic reference speed;
      wherein the maximum characteristic reference speed is the lowest characteristic speed above which performing a cutting operation on the workpiece using the cutting device without supplying the cooling fluid to the cooling is associated with thermal failure of the reference cutting device.

“Thermal failure” may comprise damage to the cutting device owing to being heated to an elevated temperature during use.

The characteristic operational speed may be at least two times the minimum characteristic reference speed.

The reference cutting operation may be a continuous cutting operation (as opposed to an intermittent or interrupted cutting operation).

Each of the characteristic speeds may be a respective cutting speed (i.e., the “minimum characteristic operational speed” is the minimum operational cutting speed, and the “maximum characteristic reference speed” is the maximum reference cutting speed).

Each of the characteristic speeds may be calculated based on a respective cutting speed and a respective feed rate. The characteristic speeds always increase with an increase of each of the respective cutting speed and respective feed rate, but they are not necessarily given equal weight in calculating the characteristic speeds. For example, each of the characteristic speeds may be the sum of the respective cutting speed and the respective feed rate, the sum of the respective cutting speed multiplied by a first coefficient and the respective feed rate multiplied by a second coefficient, the square root of the sums of the squares of the respective cutting speed and the respective feed rate, etc.

The cutting device may comprise a cutting portion made of a material selected from a group including carbide, steel, and widia.

The method may further comprise supplying a cooling fluid to the cooling cavity, thereby reducing the temperature of the cutting device near its cutting edge.

The workpiece may be made of a metal characterized by a thermal conductivity of no greater than about 100 ^{W}/_{(m·K)} (approximately 57.8 ^{Btu}/_{(hr·ft·° F.)}).

The material of the workpiece may be characterized by continuous chipping.

The material of the workpiece may be characterized by lamellar chipping.

The material of the workpiece may be characterized by short chipping.

The workpiece may be made of a material metal selected from a group including iron, copper alloys, steel, lead, titanium, and nickel.

The thin-walled structure may span between the cooling cavity and at least a portion of a relief surface and/or a rake surface of the cutting device.

The thin-walled structure may have a minimum thickness not exceeding approximately 0.7 mm.

The thin-walled structure may have a minimum thickness not exceeding approximately 0.4 mm.

The thin-walled structure may have a minimum thickness not exceeding approximately 0.2 mm.

The thin-walled structure may have a minimum thickness not exceeding approximately 0.1 mm.

The cutting device may comprise one or more ribs projecting into the cavity from a top end thereof.

The maximum characteristic reference speed may be no greater than about 100 ^{m}/_{min.} (approximately 328 ^{ft.}/_{min.}).

The maximum characteristic reference speed may be no greater than about 300 ^{m}/_{min.} (approximately 984 ^{ft.}/_{min.}).

The minimum characteristic operational speed may be no less than about 500 ^{m}/_{min.} (approximately 1640 ^{ft.}/_{min.}).

The cutting device may comprise a replaceable insert.

The cutting operation may be selected from a group including a turning operation, a milling operation, and a drilling operation.

The combination may be characterized in that the useful life of the cutting device is higher when the cutting speed is increased.

According to an eighth aspect of the presently disclosed subject matter, there is provided a method for designing a cutting device for performing a cutting operation on a workpiece, the method comprising:
selecting the workpiece;
defining a reference cutting device being characterized by reference parameters;
determining, based on the reference parameters and parameters of the workpiece, a maximum characteristic reference speed being the lowest characteristic cutting speed above which performing a reference cutting operation on the workpiece using the reference cutting device is associated with thermal failure of the reference cutting device;
designing the cutting device characterized by the reference parameters, wherein the cutting device design further comprises an internal cooling cavity defined on one side thereof by a thin-walled structure;
determining a minimum characteristic operational speed, being the highest speed below which performing a cutting operation with the cutting device is associated with structural failure of the thin-walled structure;
   wherein the thin-walled structure is characterized in that the minimum characteristic operational speed is greater than the maximum characteristic reference speed.

The reference parameters may be, e.g., the thickness of the cutting device, its shape, dimensions, etc.

The characteristic operational speed may be at least 1.5 times greater than the maximum characteristic reference speed. The characteristic operational speed may be at least two times the maximum characteristic reference speed.

The reference cutting operation may be a continuous cutting operation (as opposed to an intermittent or interrupted cutting operation).

Each of the characteristic speeds may be a respective cutting speed (i.e., the “minimum characteristic operational speed” is the minimum operational cutting speed, and the “maximum characteristic reference speed” is the maximum reference cutting speed).

Each of the characteristic speeds may be calculated based on a respective cutting speed and a respective feed rate. The characteristic speeds always increase with an increase of each of the respective cutting speed and respective feed rate, but they are not necessarily given equal weight in calculating the characteristic speeds. For example, each of the characteristic speeds may be the sum of the respective cutting speed and the respective feed rate, the sum of the respective cutting speed multiplied by a first coefficient and the respective feed rate multiplied by a second coefficient, the square root of the sums of the squares of the respective cutting speed and the respective feed rate, etc.

The cutting device may comprise a cutting portion made of a material selected from a group including carbide, steel, and widia.

The method may further comprise supplying a cooling fluid to the cooling cavity, thereby reducing the temperature of the cutting device near its cutting edge.

The workpiece may be made of a metal characterized by a thermal conductivity of no greater than about 100 ^{W}/_{(m·K)} (approximately 57.8 ^{Btu}/_{(hr·ft·° F.)}).

The material of the workpiece may be characterized by continuous chipping.

The material of the workpiece may be characterized by lamellar chipping.

The material of the workpiece may be characterized by short chipping.

The workpiece may be made of a material metal selected from a group including iron, copper alloys, steel, lead, titanium, and nickel.

120. The method according to any one of claims 108 through 119, wherein the cutting operation comprises operating the cooling arrangement to reduce the temperature of the cutting device near its cutting edge.

The thin-walled structure may span between the cooling cavity and at least a portion of a relief surface and/or a rake surface of the cutting device.

The thin-walled structure may have a minimum thickness not exceeding approximately 0.7 mm.

The thin-walled structure may have a minimum thickness not exceeding approximately 0.4 mm.

The thin-walled structure may have a minimum thickness not exceeding approximately 0.2 mm.

The thin-walled structure may have a minimum thickness not exceeding approximately 0.1 mm.

The cutting device may comprise one or more ribs projecting into the cavity from a top end thereof.

The maximum characteristic reference speed may be no greater than about 100 ^{m}/_{min.} (approximately 328 ^{ft.}/_{min.}).

The maximum characteristic reference speed may be no greater than about 300 ^{m}/_{min.} (approximately 984 ^{ft.}/_{min.}).

The minimum characteristic operational speed may be no less than about 500 ^{m}/_{min.} (approximately 1640 ^{ft.}/_{min.}).

The cutting device may comprise a replaceable insert.

The cutting operation may be selected from a group including a turning operation, a milling operation, and a drilling operation.

The method may be characterized in that the useful life of the cutting device is higher when the cutting speed is increased.

According to a ninth aspect of the presently disclosed subject matter, there is provided a cutting device designed according to the method of the eighth aspect of the presently disclosed subject matter.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a cutting tool according to the presently disclosed subject matter;

FIG. 2A is a perspective view of a cutting insert of the cutting tool illustrated in FIG. 1;

FIG. 2B is a cross-sectional view taken along line II-II in FIG. 2A;

FIG. 3A is a perspective view of a cutting tool holder of the cutting tool illustrated in FIG. 1;

FIG. 3B is a cross-sectional view taken along line III-III in FIG. 3A;

FIG. 4 is a close-up cross-sectional view taken along line IV-IV in FIG. 1;

FIG. 5 illustrates a method for performing a cutting operation on a workpiece; and

FIG. 6 schematically illustrates a combination for implementing the method of FIG. 5.

### DETAILED DESCRIPTION

The presently disclosed subject matter relates to a method for performing a cutting operation on a workpiece. The method is especially useful for cutting operations performed on metals which are relatively inefficient at transmitting heat therethrough, for example being characterized by a thermal conductivity of less than about 100 ^{W}/_{(m·K)} (approximately 57.8 ^{Btu}/_{(hr·ft·° F.)}). While the method is not limited to use with a particular design of cutting tool, a non-limiting example of a cutting tool which may be suitable for implementing a cutting operation as per the method will be described.

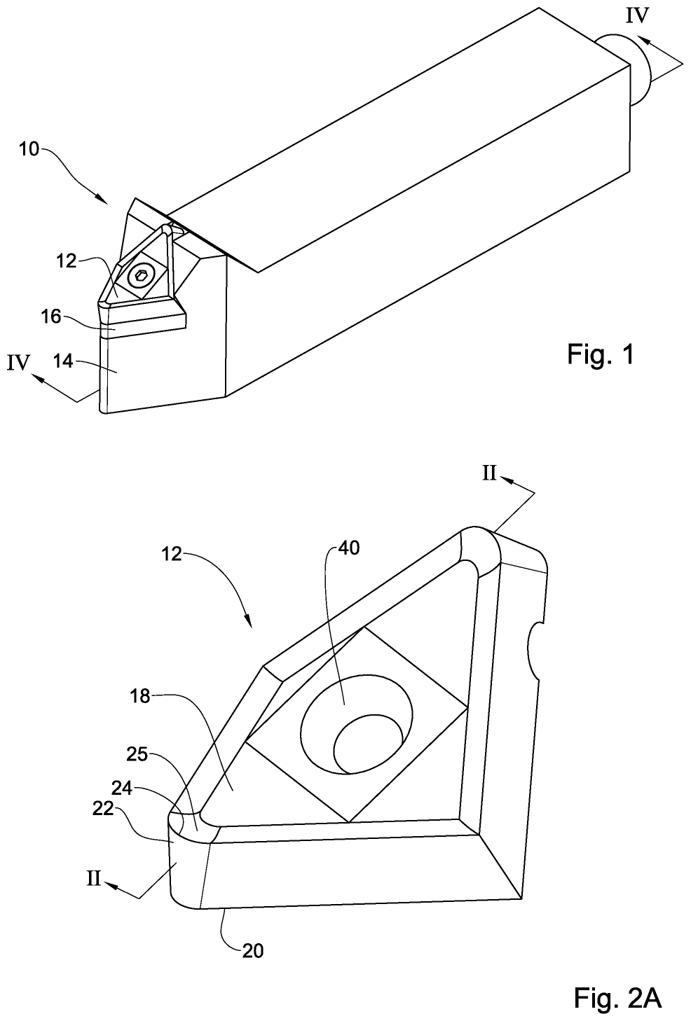

As illustrated in FIG. 1, a cutting tool, which is generally indicated at 10, comprises a cutting insert 12 securely mounted within a cutting tool holder 14. The cutting tool 10 may optionally comprise a base plate 16, for example made of widia, disposed between the cutting insert 12 and the cutting tool holder 14.

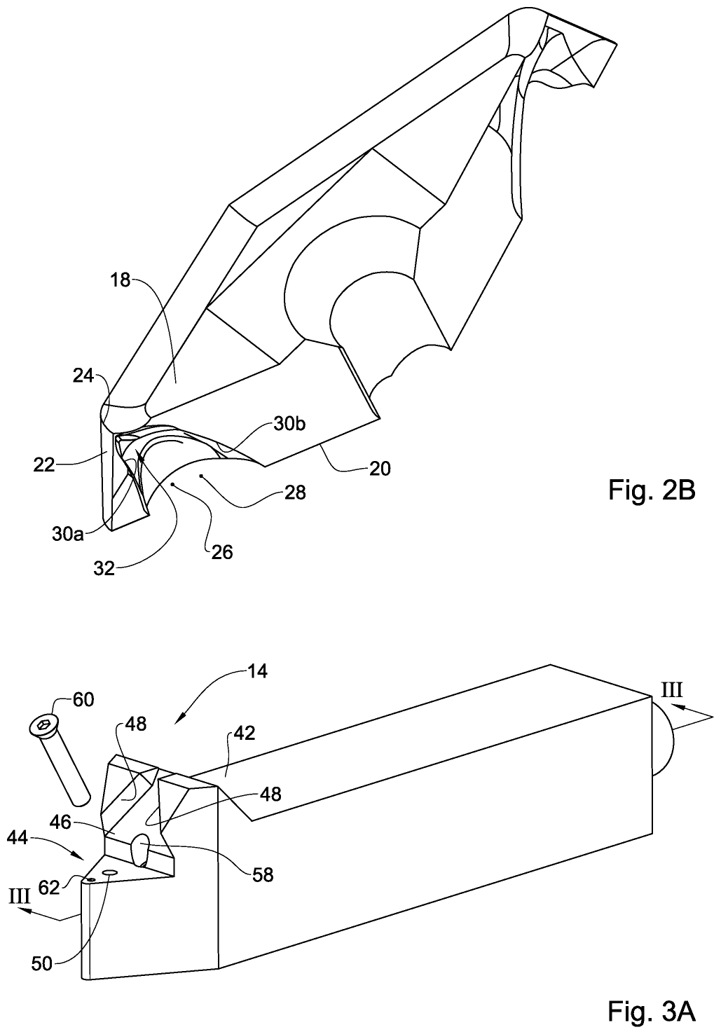

As illustrated in FIGS. 2A and 2B, the cutting insert 12 comprises a top surface 18, a bottom surface 20, and a side surface 22 spanning therebetween. When the cutting insert 12 is mounted in the cutting tool holder 14, a portion of the top surface 18 constitutes a rake surface, and a portion of the side surface 22 constitutes a relief surface, with a cutting edge 24 defined therebetween at the intersection of the rake and relief surfaces (i.e., the top and side surfaces), with the bottom surface 20 typically being held flat against the cutting tool holder. The cutting insert 12 may further comprise a chip breaker 25, for example formed as a curved channel formed around at least a portion of the perimeter of the top surface 18.

It will be appreciated that herein the disclosure and claims, terms relating to direction, such as top, bottom, up, down, etc., and similar/related terms are used with reference to the orientation in the accompanying drawings based on a typical usage of the cutting tool 1 and its constituent elements, unless indicated otherwise or clear from context, and is not to be construed as limiting. Similarly, front (and related terms) refers to a direction toward a workpiece, and rear (and related terms) refers to a direction away from the workpiece.

The cutting insert 12 is formed with a cooling cavity, which is generally indicated at 26. The cooling cavity 26 comprises an opening 28 formed in the bottom surface 20 of the cutting insert 12, thereby providing access to the cooling cavity from the bottom side thereof. When the cutting insert 12 is mounted in the cutting tool holder 14, e.g., as described above, the opening 28 of the cooling cavity 26 abuts the cutting tool holder 14. Front and rear interior surfaces 30a, 30b of the cooling cavity 26 converge toward a top end 32 thereof, such that the width of the cooling cavity decreases along its height. Such a shape of the cooling cavity 26 facilitates continuous introduction of a cooling medium (e.g., water) therein and simultaneous exit thereof during a cutting operation (for example along a flow path indicated by arrow A in FIG. 4). Accordingly, the opening 28 may constitute an entrance and an exit of the cooling cavity 26.

The cooling cavity 26 is formed such that its top end thereof is adjacent the cutting edge 24, e.g., wherein the front interior surface 30a of the cooling cavity and a front of the side surface 22 (i.e., the relief surface of the cutting insert 12) define a thin-walled structure therebetween.

According to some examples, one or more ribs 34 (references herein to a single element, e.g., a rib, are to be understood as implicitly including examples wherein more than one of such element is provided, unless otherwise evident from context, mutatis mutandis) may be formed on the interior surface(s) 30a, 30b of the cooling cavity 26, for example at or near the top end 32 thereof. Such a rib 34 may facilitate reducing the thickness of thin-walled structure in the vicinity of the cutting edge 24, further reducing the necessary thickness thereof to withstand forces which arise during a cutting operation. In addition, providing ribs 34 increases the surface area of the interior surface(s) 30a, 30b of the cooling cavity 26, thereby facilitating a more efficient cooling by the cooling medium.

The cutting insert 12 may comprise other features as will be recognized by one having skill in the art, including, but not limited to, a mounting aperture 40, without departing from the scope of the presently disclosed subject matter, mutatis mutandis.

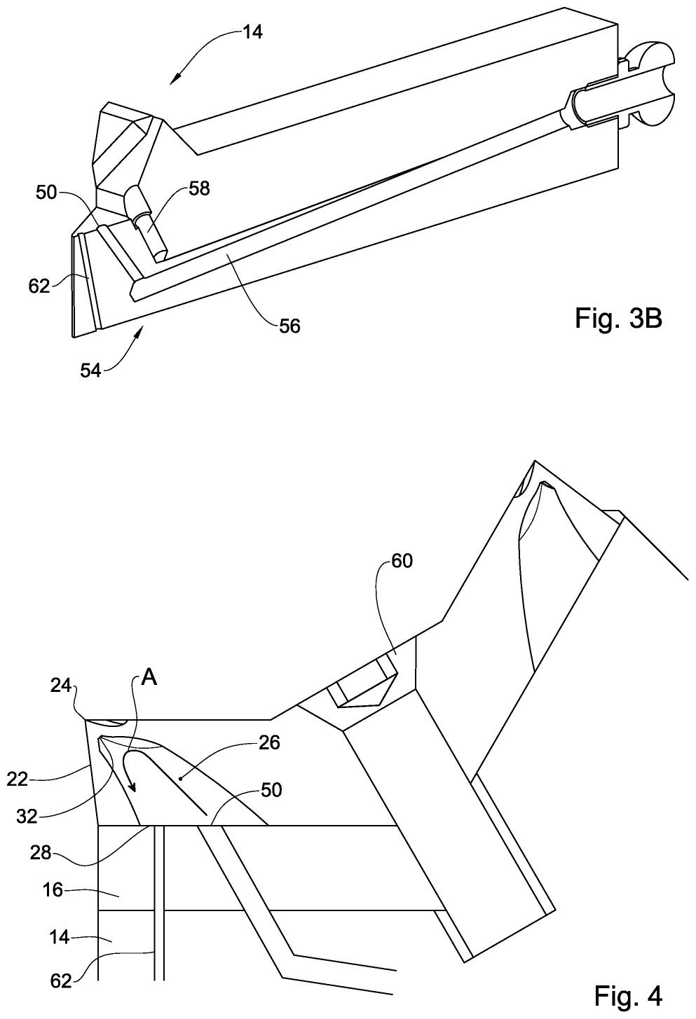

As illustrated in FIGS. 3A and 3B, the cutting tool holder 14 comprises a main body 42 with an insert seat space 44, for mounting therein of the cutting insert 12, formed at a distal end thereof. The insert seat space 44 is defined between a base 46 and two sidewalls 48 extending generally upwardly therefrom. The base 46 and sidewalls 48 may be formed correspondingly with the bottom and rear side surfaces 20, 22, respectively, of the cutting insert 12. (In the example illustrated in FIGS. 3A and 3B, the base 46 corresponds to a base of the base plate 16, not illustrated, which has an upper surface corresponding to the bottom surface 20 of the cutting insert 12.)

According to some example, the cutting tool holder 14 further comprises a cooling provisioning arrangement, which is generally indicated at 54. The cooling provisioning arrangement 54 may comprise a conduit 56, for example along the length of the main body 42, open at a discharge end thereof at a fluid inlet 50 formed on the base 46, disposed so as to be under the cooling cavity 26 of the cutting insert 12 when mounted thereupon. The conduit 56 may further be open, at a supply end thereof, to a cooling medium source (not illustrated). The fluid inlet may be of any suitable shape, such as round, elliptical, oval, polygonal, etc. Moreover, the fluid inlet 50 may be formed at the end of a nozzle (not illustrated) which projects from the base 46 into the cooling cavity 26 when the cutting insert 12 is mounted in the insert seat space 44.

The cutting tool holder 14 may comprise a fastening bore 58, for receipt and securing therein of a fastening member such as a screw 60, open to the insert seat space 44. The fastening bore 58 may be provided according to any suitable design, for example as known in the art. The cutting tool holder 14 may further comprise a fluid outlet 62 formed on the base 46 and open to the insert seat space 44, for example distally from the fluid inlet 50, configured to facilitate discharge of cooling medium from the cooling cavity 26 during use, while cooling medium is supplied. The fluid outlet 62 may be connected to a discharge conduit (not illustrated), or open below the cutting tool holder 14, allowing cooling medium to freely drain therefrom. It will be appreciated that the path of cooling medium flow within the cooling cavity 26 may be at least partially influenced by the parameters, including positions, of the fluid inlet 50 and the fluid outlet 62.

According to some examples, multiple fluid inlets 50 and/or fluid outlets 62 may be provided.

In use, for example as best illustrated in FIG. 4, the cutting insert 12 is inserted into the insert seat space 44, and secured therein, for example by passing the screw 60 through the mounting aperture 40 of the cutting insert, and securing it in the fastening bore 58 of the cutting tool holder 14. The bottom surface 20 of the cutting insert 12 lies in registration on the base 46 of the cutting tool holder, and its rear side surfaces 22 lie in registration against the sidewalls 48 thereof.

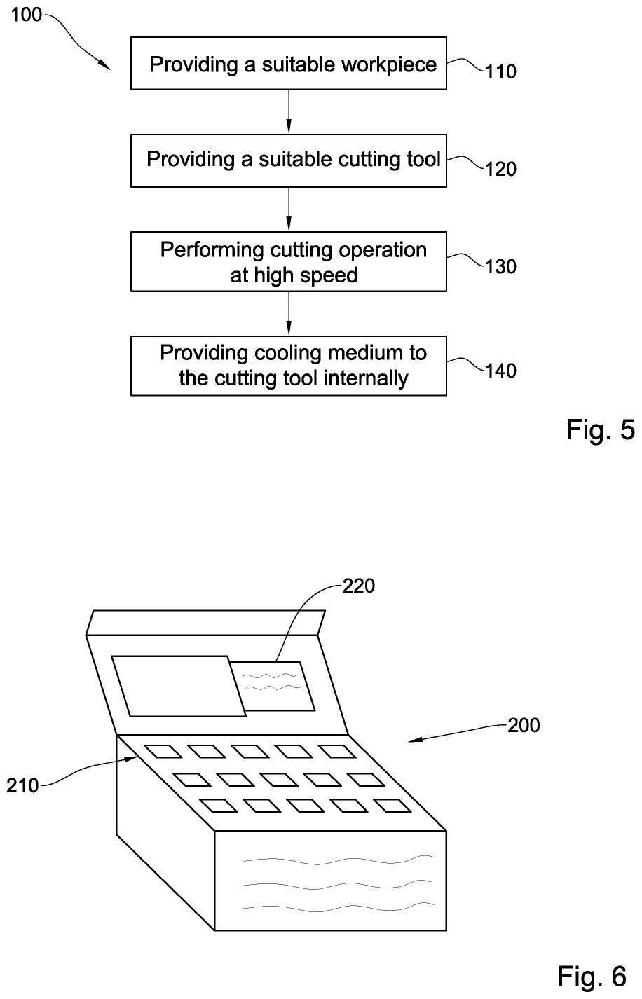

As illustrated in FIG. 5, there is provided a method, generally indicated at 100, for performing a cutting operation on a workpiece.

In step 110 of the method, a suitable workpiece is provided. As mentioned above, the workpiece is a metal (including mixtures, compounds, alloys, composites, etc.) which is relatively inefficient at transmitting heat therethrough, and thus experiences a significant rise in temperature during a cutting operation, in particular when compared to a similar workpiece, but made of a material which more efficiently transmits heat, undergoing the same cutting operation.

For example, the workpiece may be made of a material which is characterized by a thermal conductivity (at room temperature) of less than about 100 ^{W}/_{(m·K)} (approximately 57.8 ^{Btu}/_{(hr·ft·° F.)}). Examples of such materials include, but are not limited to, iron, some copper alloys (e.g., bronze), steel, lead, titanium, and nickel.

The workpiece may be further characterized in that it tends to undergo continuous, lamellar, and/or short chipping during a cutting operation, as is well known in the art.

In step 120 of the method, a suitable cutting tool is provided. The cutting tool may comprise an insert, for example as described above with reference to and as illustrated in FIGS. 1 to 4 (references in the description of the method 100 and in the appended claims to an “insert” alone are to be understood as including an integral cutting tool, i.e., one which is not designed for use with a replaceable insert, mutatis mutandis).

A suitable cutting insert for implementing the method is one which is designed to withstand the high temperature it will be subjected to during the cutting operation. For example, the cutting insert may be designed for efficient cooling during a cutting operation, for example as described above. In particular, the relief surface of the cutting insert may be disposed on a thin-walled structure, such as adjacent a cooling cavity as described above. According to some examples, the thin-walled structure has a minimum thickness of about 0.7 mm (approximately 0.275 in.). According to other examples, the thin-walled structure has a minimum thickness of about 0.4 mm (approximately 0.1575 in.). The cutting insert (or tool, if integral) may be made from carbide, steel, widia, or any other suitable material.

In step 130 of the method, the cutting operation is performed by the cutting tool on the workpiece. The cutting speed is no less than about 300 ^{m}/_{min.} (approximately 984 ^{ft.}/_{min.}).

According to some examples, the cutting speed in no less than about 500 ^{m}/_{min.} (approximately 1640 ^{ft.}/_{min.}). The cutting operation may be characterized in that continuous, lamellar, and/or short chipping occurs. The cutting operation may be a turning operation, a milling operation, or a drilling operation, or any other suitable operation.

According to some examples, the cutting speed may be selected in order to increase the useful life of the cutting tool. It has been found that according to the method of the presently disclosed subject matter, an increase in cutting speed may be associated with an increased useful life of the cutting tool, despite the increased heat which may be generated.

According to other examples, the chip thickness may be selected. It has been found that higher chip thicknesses may be obtained by increasing the cutting speed. Alternatively, the chip thickness may be maintained or decreased, thereby allowing a higher cutting speed to be used. This may result in an overall increase in the rate of material removal, as the increased speed may more than compensate for the decreased thickness of the chips.

In step 140 of the method, cooling fluid is provided internally of the cutting insert, inter alia contacting and cooling an inside surface of the cooling cavity.

It will be appreciated that the method as described above permits cutting speeds which are significantly higher than those currently achievable using cutting inserts which are not efficiently cooled. The structure of the cutting insert of the present method, in particular the thin-walled structure on which the relief surface is formed, allows for dissipating the heat generated by operating at the high speed required by the method, in particular wherein the workpiece itself does not efficiently dissipate the heat, i.e., it is characterized by a relatively low thermal conductivity, as described above.

It has been found that while the disposition of the relief surface on a thin-walled structure lowers the strength of the cutting insert, and specifically in a location thereof subject to a significant portion of the cutting force, by operating it at a high cutting speed such as described above, the advantages in heat dissipation inherent in such a design more than compensate for the reduction in strength of the cutting insert. As the cutting force is reduced at high cutting speeds, for example above about 300 ^{m}/_{min.} (approximately 984 ^{ft.}/_{min.}), about 500 ^{m}/_{min.} (approximately 1640 ^{ft.}/_{min.}), or higher, depending on the application, the strength requirements of the cutting insert are similarly reduced. Moreover, the reduction in cutting force may obviate the need to provide the base plate 16 described above with reference to and illustrated in FIG. 1.

Accordingly, the thin-walled structure both facilitates the high cutting speed of the method 100 and is facilitated thereby, i.e., the thin-walled structure provides the necessary cooling to operate at the high cutting speed, and the high cutting speed is associated with a reduction of cutting force which is suitable for a cutting insert of reduced strength. Thus, the thin-walled structure may lack the strength to withstand cutting force of lower speeds, e.g., it may exhibit structural failure if the cutting operation of step 130 is performed below about 100 ^{m}/_{min.} (approximately 328 ^{ft.}/_{min.}). According to some examples, it may exhibit structural failure if the cutting operation of step 130 is performed below about 300 ^{m}/_{min.} (approximately 984 ^{ft.}/_{min.}).

It will be appreciated that the method 100 is designed such that the cutting insert, in particular the thin-walled structure thereof, does not ordinarily experience catastrophic structural failure during the useful life thereof, i.e., before its cutting edge undergoes sufficient wear and tear to be rendered unsuitable for use.

In view of the above, the cutting insert may be designed such that its thin-walled structure comprises a fault region, being a portion thereof which is expected to experience structural failure during a cutting operation when high cutting forces are experienced, for example owing to the low thickness thereof. At the same time, the low thickness of the thin-walled structure allows a high level of cooling, for example by providing a cooling fluid internally, such as described above. The high level of cooling allows the cutting operation to be performed at a high cutting speed, as the temperature of the cutting insert is kept low while the temperature of the workpiece is raised to an extremely high temperature. This high temperature of the workpiece is associated with lower cutting forces, which are below those which are associated with structural failure of the fault region. Accordingly, the thickness of the thin-walled region is designed such that it allows higher cutting speeds (i.e., by increasing the level of cooling of the cutting insert sufficient to protect it from thermal failure) which are associated with cutting forces which are below those which would cause structural failure of the thin-walled structure, e.g., in the fault region.

One having skill in the art will recognize that the method described above is not limited to implementation with a cutting insert as per described above with reference to FIGS. 1 to 4, but that other examples of cutting inserts and/or tools may be used therefor without departing from the scope of the presently disclosed subject matter, mutatis mutandis.

In addition, one having skill in the art will recognize that the method described above may allow a single cutting insert to be suitable for a wide range of cutting conditions, i.e., many different suitable combinations of materials, cutting angles, cutting speeds, etc.

As illustrated in FIG. 6, there is provided a combination, for example a kit or a set, which is generally indicated at 200, comprising a combination of one or more cutting inserts 210 and/or one or more cutting tools (not illustrated), for example as described above with reference to and illustrated in FIGS. 1 to 4, and at least one article 220 providing, directly or indirectly, instructions for using the cutting inserts 210 according to the method described above with reference to and illustrated in FIG. 5.

The instructions may comprise any one or more of the following:
a list of one or more materials suitable to be cut with the cutting inserts 210;
suitable cutting speeds for each of the materials;
one or more suitable cooling fluids for providing to the cooling cavity during use of the inserts in a cutting operation;
rate of supply of one or more of the cooling fluids;
estimated useful life of a cutting insert under one or more sets of conditions; and
chip thickness.

According to some examples, the instructions may provide multiple values, each associated with a different cutting speed, of the estimated useful life of a cutting insert 210 when performing a cutting operations on workpieces of the same material. In particular, the estimated useful life may be higher for higher cutting speeds for a given material of the workpiece.

According to some examples, the instructions may provide multiple values, each associated with a different cutting speed, of the chip thickness for cutting operations on workpieces of the same material. According to some examples, the chip thickness may be higher for higher cutting speeds for a given material of the workpiece. According to other examples, higher cutting speeds may be associated with smaller chip thicknesses, for example such that a higher rate of material removal is provided by combinations with higher cutting speeds.

The article 220 may comprise printed material or electronic media. According to some examples, at least a portion of the instructions are displayed (e.g., printed) or encoded in the article itself 220. According to other examples, the article 220 provides information for accessing at least a portion of the instructions, for example by reference to a catalog or handbook, or with reference to a reference which may be accessed over a computer network (e.g., the internet). The information may be printed, for example comprising identification of a web resource containing the instructions, for example textually, e.g., by providing a uniform resource locator and/or encoded in a matrix barcode, or may be encoded electronically, e.g., by providing a hyperlink to a web resource containing the instructions. According to further examples, the article comprises a catalog or handbook which references the one or more cutting inserts 210 and provides at least a portion of the instruction.

It will be appreciated that while the method and combination described above relates to an example in which a cutting operation is performed on a metal having a thermal conductivity of no greater than about 100 ^{W}/_{(m·K)} (approximately 57.8 ^{Btu}/_{(h·ft·° F.)}), according to other examples the cutting operation may be performed on other materials, without departing from the scope of the presently disclosed subject matter, mutatis mutandis.

For example, a method and/or combination may be provided which is similar to that described above, in particular with reference to and illustrated in FIGS. 5 and/or 6, but wherein the workpiece is made of a metal which is relatively efficient at transmitting heat therethrough, for example being characterized by a thermal conductivity of greater than about 100 ^{W}/_{(m·K)} (approximately 57.8 ^{Btu}/_{(hr·ft·° F.)}), for example being greater than about 200 ^{W}/_{(m·K)} (approximately 116 ^{Btu}/_{(hr·ft·° F.)}) or than about 300 ^{W}/_{(m·K)} (approximately 173 ^{Btu}/_{(hr·ft·° F.)}). Examples of such materials include, but are not limited to, aluminum, copper, brass, gold, tungsten, etc. According to these examples, the minimum cutting speed may be greater than 300 ^{m}/_{min.} (approximately 984 ^{ft.}/_{min.}), depending on the metal used. According to some examples, the minimum cutting speed may be greater than about 500 ^{m}/_{min.} (approximately 1640 ^{ft.}/_{min.}).

According to other examples, a method and/or combination may be provided which is similar to that described above, in particular with reference to and illustrated in FIGS. 5 and/or 6, but wherein the workpiece is made of a non-metal, for example wood, a thermoplastic polymer, etc. Such materials are often relatively inefficient at transmitting heat therethrough, for example being characterized by a thermal conductivity much less than about 100 ^{W}/_{(m·K)} (approximately 57.8 ^{Btu}/_{(hr·ft·° F.)}).

Those skilled in the art to which this invention pertains will readily appreciate that numerous changes, variations, and modifications can be made without departing from the scope of the presently disclosed subject matter, mutatis mutandis.

1-131. (canceled)

132. A method for performing a cutting operation on a workpiece, the method comprising:
providing said workpiece, the workpiece being made of a metal characterized by a thermal conductivity of no greater than about 100 ^{W}/_{(m·K)} (approximately 57.8 ^{Btu}/_{(hr·ft·° F.)});
providing a cutting device including a cutting insert, said cutting insert comprising an internal cooling cavity defined on one side thereof by a thin-walled structure, a rake surface, a relief surface, and a cutting edge defined therebetween, at least one of the relief and rake surfaces being disposed on said thin-walled structure; and
performing, using said cutting device, a cutting operation on said workpiece, wherein the cutting speed is no less than about 500 ^{m}/ₘᵢₙ (approximately 1640 ^{ft.}/_{min.}).

133. The method according to claim 132, wherein said metal is characterized by either one of continuous chipping, lamellar chipping, or short chipping.

134. The method of claim 132, wherein said thin-walled structure has a minimum thickness not exceeding approximately 0.7 mm.

135. The method according to claim 132, wherein said thin-walled structure has a minimum thickness not exceeding approximately 0.4 mm.

136. The method of claim 132, wherein said cutting device is characterized in that said thin-walled structure is not suited to withstand cutting forces associated with lowering the cutting speed to less than about 100 ^{m}/ₘᵢₙ (approximately 328 ^{ft.}/_{min.}).

137. The method of claim 136, wherein said cutting device is characterized in that said thin-walled structure is not suited to withstand cutting forces associated with lowering the cutting speed to less than about 300 ^{m}/ₘᵢₙ (approximately 984 ^{ft.}/_{min.}).

138. The method of claim 132, further comprising supplying a cooling fluid to the cooling cavity during said cutting operation.

139. The method of claim 132, being characterized in that the useful life of said cutting device is higher when said cutting speed is increased.

140. The method of claim 132, being characterized in that higher chip thicknesses are obtained when said cutting speed is increased.

141. A combination, comprising:
one or more cutting devices, each comprising a cutting insert having an internal cooling cavity defined on one side thereof by a thin-walled structure, a rake surface, a relief surface, and a cutting edge defined therebetween, at least one of the relief and rake surfaces being disposed on said thin-walled structure; and
at least one article providing instructions for use of said cutting devices in accordance with a method for performing a cutting operation on a workpiece, the method comprising:
providing said workpiece, the workpiece being a metal characterized by a thermal conductivity of no greater than about 100 ^{W}/_{(m·K)} (approximately 57.8 ^{Btu}/_{(hr·ft·° F.)}); and
performing, using one of said cutting devices, a cutting operation on said workpiece, wherein the cutting speed is no less than about 500 ^{m}/ₘᵢₙ (approximately 1640 ^{ft.}/_{min.}).

142. The combination of claim 141, wherein said instructions indicating two or more values of estimated useful life for each cutting device when performing a cutting operation on a workpiece of a specified material, each of said values being associated with a different cutting speed, wherein the values of estimated useful life increase with increased cutting speeds.

143. The combination of claim 134, wherein said instructions indicating two or more values of chip thickness for each cutting device when performing a cutting operation on a workpiece of a specified material, each of said values being associated with a different cutting speed, wherein the values of chip thickness increase with increased cutting speeds.

144. A method for performing a cutting operation on a workpiece, the method comprising:
providing said workpiece;
providing a cutting device comprising a cutting insert, said cutting insert comprising an internal cooling cavity defined on one side thereof by a thin-walled structure; and
performing, using said cutting device, a cutting operation on said workpiece at a characteristic operational speed being no less than a maximum characteristic reference speed;
wherein said maximum characteristic reference speed is the highest characteristic speed below which performing a reference cutting operation on the workpiece with the cutting device is associated with structural failure of said thin-walled structure.

145. The method of claim 144, wherein said characteristic operational speed is at least 1.5 times greater than the maximum characteristic reference speed.

146. The method of claim 144, wherein said reference cutting operation is a continuous cutting operation, wherein each of the characteristic speeds is a respective cutting speed, and wherein each of the characteristic speeds is calculated based on a respective cutting speed and a respective feed rate.

147. The method of claim 144, further comprising supplying a cooling fluid to the cooling cavity, thereby reducing the temperature of the cutting device near its cutting edge.

148. The method of claim 144, wherein said workpiece is made of a metal characterized by a thermal conductivity of no greater than about 100 ^{W}/_{(m·K)} (approximately 57.8 ^{Btu}/_{(hr·ft·° F.)}).

149. The method of claim 144, wherein said maximum characteristic reference speed is no greater than about 100 ^{m}/ₘᵢₙ (approximately 328 ^{ft.}/_{min.}).

150. The method of claim 144, wherein said maximum characteristic reference speed is no greater than about 300 ^{m}/ₘᵢₙ (approximately 984 ^{ft.}/_{min.}).

151. A combination comprising:
one or more cutting devices, each comprising an internal cooling cavity defined on one side thereof by a thin-walled structure; and
at least one article providing instructions for use of one of said cutting devices using the method according to claim 144.
